(19) United States
(12) Patent Application Publication
(10) Pub. No.: US 2004/0166746 A1
(43) Pub. Date: Aug. 26, 2004

(54) ELECTRIC PERSONAL WATER CRAFT

(76) Inventor: Mark H. Krietzman, Palos Verdes Estates, CA (US)

Correspondence Address: Mark Krietzman, P.O. Box 3185, Palos Verdes, CA, 90274, US

(21) Appl. No.: 10/374,477

(22) Filed: Feb. 25, 2003

(51) Int. Cl. B60L 11/02

(52) U.S. Cl. 440/6

(57) ABSTRACT

An electric personal water craft. The electric personal water craft produces its own electricity from an on-board fuel cell system. Hydrogen fuel is stored within the hull of the personal water craft. The heat produced by the fuel cell stack is dissipated to the marine environment for heat management of the fuel cell power system.

### BACKGROUND OF THE INVENTION

1. Field of the Invention

This present invention relates to an electric personal watercraft powered by a fuel cell stack. More specifically, to small sized marine craft powered by a fuel cell stack and at least one electric motor.

2. Related Art

The personal water craft PWC is commonly known as a small vessel which uses an inboard internal combustion engine (ICE) to power a water jet pump. The PWC is often operated by a person(s) sitting, standing or kneeling on the vessel. The PWC has limited hull space for electronics, fuel and propulsion systems.

The PWC can also be dirty and noisy. The PWC subject of restrictions in areas such as national parks See 36 Code of Federal Regulations 13.63 (h) (i). The majority of PWC's are powered by a two-stroke ICE which uses a mixture of gasoline and oil for fuel. Unfortunately, about one third of the oil and gasoline mixture is unburned and introduced into the surrounding environment. The California Air Resources Board (CARB) has reported that a days ride on a 100 horsepower PWC emits the same amount of smog as driving 100,000 miles in a modern automobile, see “Proposed Regulations for Gasoline Spark-Ignition Marine Engines, Draft Proposal Summary” Mobile Source Control Division, State of California Air Resources Board; Jun. 11, 1998.

PWCs are highly maneuverable making them suitable for a variety of recreational, law enforcement and military activities. However, the noise parameters of the ICE limit the quiet or stealth-like use of traditional highly maneuverable PWC. Some PWC are constructed with two seats side by side with occupants surrounded by at least a partial hull.

Electric motors have been used in marine crafts for slow speed navigation and trolling. Electric motors have also been used in marine crafts with a primary propulsion ICE as secondary propulsion, see generally U.S. Pat. Nos. 6,305,994 and 6,361,385 issued to Bland et. al. Batteries (lead acid and the like) have been used to supply electricity for propulsion of marine water crafts. Conventional batteries are, however, bulky, heavy, and slow to recharge. A PWC has limited weight capacity and limited hull space which cannot easily accommodate a group of batteries. A PWC is often used for day use in a recreational setting which makes long recharge times associated with batteries inconvenient. Accordingly, batteries are a poor choice to power an electric PWC is one is striving for performance characteristics not unlike PWC's with ICEs.

A Proton Exchange Membrane Fuel Cell “PEMFC” generates electricity through the passage of protons from hydrogen atoms through a membrane. The movement of the disassociated electrons around the membrane generates electricity. As shown in equation 1 (the anode half reaction) and equation 2 (the cathode half reaction).

H₂>2H⁺+2e⁻ Equation 1

1/2 O₂+2H⁺+2e⁻>H₂O+Heat Equation 2

The heat generated during the passage of the electrons around the membrane and the formation of water at the cathode. The temperature for practical operation of the PEMFC is about 80 C to about 120 C However, the heat generated during operation, if not removed can cause the PEMFC to exceed 120 C. With increased temperature the performance of the PEMFC can diminish. See generally U.S. Pat. No. 6,066,408 issued to Vitale and Jones. Accordingly, it would also be desirous to have a fuel cell power supply for a PWC with integrated heat management.

It would therefore be desirous to have a PWC, with the primary propulsion system being electric, without a battery power supply. Absent from the art is such a PWC.

### SUMMARY OF INVENTION

The present invention is an electric PWC with a fuel cell providing the electricity for the propulsion. The small partially hollow hull of a PWC, or other small marine craft, which does not provide space for heavy and bulky batteries is well suited to carry an on-board supply of hydrogen. The PWC in another configuration carries a hydrogen rich fuel which can be reformed on-board to provide the hydrogen gas for the fuel cell. The Oxygen for the fuel cell is supplied from atmospheric air via an air compressor.

Thermal management of the fuel cell stack is accomplished by either a heat exchanger through the hull, or with a radiator utilizing a flow of water from the marine environment. Thermal management of the fuel cell stack also can reduce the interior hull temperature. Reducing the interior hull temperature also can reduce the temperature of components within the hull.

For a fuel cell powered PWC with one electric motor, a single impeller in a water tunnel can provide a water jet stream, exiting a discharge nozzle at the rear of the PWC, for propulsion. A directional nozzle affixed to the discharge nozzle can be used for navigation. The combination of a water tunnel, impeller and discharge nozzle form the main components of a water jet propulsion module. The directional nozzle is connected to handle bars which can be used to help steer/navigate the PWC via movement of the directional nozzle. A hand grip on the handle bars is used to adjust the output of the electric motor.

The PWC may have two or more motors each powered by the fuel cell stack and each connected to a propulsion module. For a dual motor PWC, with rearward discharge nozzles, navigation can be accomplished by controlling the discharge of water from either or both of the discharge nozzles and/or by adding controllable directional nozzles.

The PWC may have one or more rearward discharge nozzles, at least one forward discharge nozzle on each side of the hull. By controlling the output of each forward propulsion module and /or the rearward propulsion modules, propulsion and navigation of the PWC is controlled.

Other features and advantages of the present invention will be set forth, in part, in the descriptions which follow and the accompanying drawings, wherein the preferred embodiments of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations particularly pointed out in the appended claims.

### BRIEF DESCRIPTION OF THE DRAWINGS

FIG. 1A is an external side view of an electric PWC.

FIG. 1B is a cut-away side view of the embodiment of FIG. 1A.

FIG. 1C is a bottom view of the embodiment of FIG. 1A.

FIG. 1D is a cut-away back view of the embodiment of FIG. 1A at line A-A.

FIG. 1E is a top view of the embodiment of FIG. 1A.

FIG. 2 is a block diagram of the major components of the power generation and propulsion system of an EFC PWC.

FIG. 3A is a back view of a dual motor PWC.

FIG. 3B is a partial bottom view of the embodiment of FIG. 3A.

FIG. 3C is a top view diagram, showing a turn, of the embodiment of FIG. 3A.

FIG. 4 is a block diagram of power and navigation components for a dual motor PWC.

FIG. 5 is a partial bottom view of an alternate embodiment of a dual motor PWC.

FIG. 6 is a block diagram of power and navigation components for a dual motor PWC.

FIG. 7 is a bottom of another embodiment of a PWC.

FIG. 8 is a block diagram of power and navigation components for a triple motor PWC.

FIG. 9 is a side representational view of a PWC with radiator cooling.

### DETAILED DESCRIPTION OF THE PREFERRED EMBODIMENTS OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure.

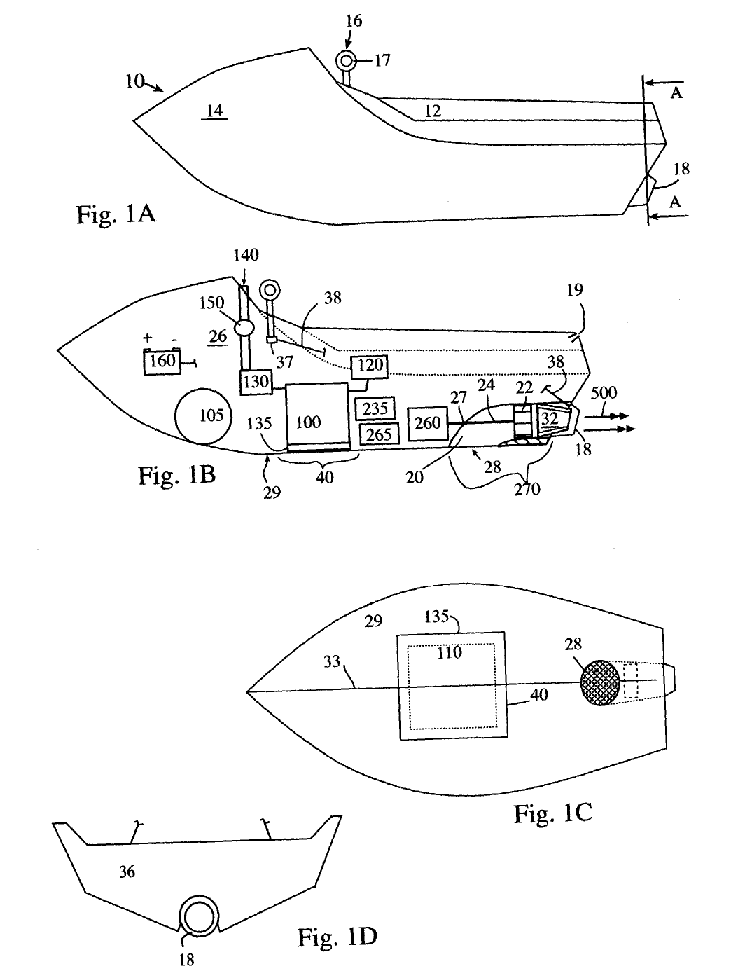

Shown in FIGS. 1A-1E is an electric personal water craft “PWC” 10. The PWC has a seat 12 raised above the hull 14, the hull 14 has hollow portions therein. A handle bar on a support 16 is used for gripping. A hand grip control 17 can be mounted on the handle bar on a support 16. The hand grip control 17, in this embodiment, is a substantially a motorcycle-type throttle which is well known in the art. The hand grip control 17 is used for speed control. A steering nozzle 18 extends from the back of the hull 14. An electric motor powered by electricity generated from the fuel cell provides the propulsion for of the PWC in a marine environment.

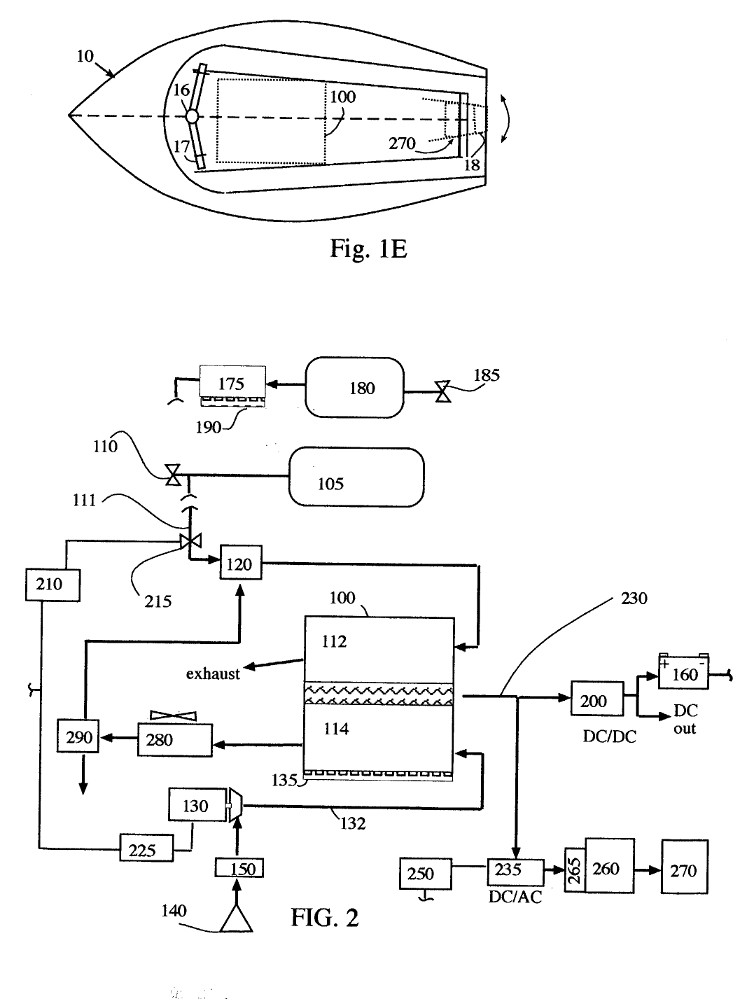

A schematic for the major components of an “electric fuel cell” (EFC), PWC is shown in FIG. 2. The components of the EFC PWC are placed inside the hull 14 or extending therefrom. To supply hydrogen to the “proton exchange membrane fuel cell stack” (PEMFC) 100 is a refillable hydrogen storage tank 105 with a fill valve 110 connected to a pressure rated hydrogen feed line 111 which is connected to the anode(s) 112 of the fuel cell stack. The hydrogen storage tank should have a pressure rating of at least 1000 psi and more preferably a pressure rating of at least 5000 psi, and most preferably a pressure rating of at least 10,000 psi.

The hydrogen feed line 111 passes through a humidity control device 120 to add moisture to the gaseous hydrogen before it flows to the PEMFC 100. To supply oxygen to the PEMFC 100 an air compressor 130 draws atmospheric air down an air intake 140 through a filter 150 and directs the compressed air, through an air feed line 132 to the cathode(s) 114 of the PEMFC 100. The air compressor 130 is connected to a battery 160 to initiate the air compressor 130 operation. Vents 19 are provided in the hull 14.

Once the PEMFC 100 is operating (generating electricity) a DC/DC converter 200 may be used to step down the voltage and power on board systems such as the compressor 130 and other low voltage components, and recharge the back-up battery 160.

As indicated in equation 2 the operation of the PEMFC 100 generates heat. The PEMFC 100 is most efficient when operating between about 80 and about 120 C. By thermally connecting the PEMFC 100 with a fuel cell heat exchanger 135, through a heat exchange region 40 of the hull 14, to the marine environment the heat from operating the PEMFC 100 can be dissipated, dispersed and /or managed. Heat exchangers are well known in the art. In this embodiment the heat exchanger 135 is a finned metallic portion. Other configurations and types of heat exchangers, coolers, or radiators may also be suitable.

An alternate hydrogen supply system is also shown in FIG. 2. A reformer 175, which generally comprises a combustion chamber and a reaction chamber, is used to free gaseous hydrogen from a hydrogen rich fuel. The hydrogen rich fuel is supplied to the reformer 175 from an internal fuel tank 180. A fuel fill valve 185 is used to refill the fuel tank.

Reformers for generating hydrogen from hydrogen rich fuels are well represented in the art. No specific reformer is called out for. But rather, a reformer which can provide an adequate quantity of gaseous hydrogen to supply the consumption of the fuel cell stack 100. The reformation process is exothermic (heat producing) and a reformer heat exchanger 190 is shown in FIG. 2. The reformer heat exchanger 190 is used to thermally connects the reformer 175 to the marine environment (via a heat exchange region 40 of the PWC hull shown in FIG. 1C) to manage the heat generated by the reformer 175.

A fuel system controller 210, is used to control the on/off function of the hydrogen supply valve the 215 and the compressor 130 motor controller 225. Electricity from the fuel cell stack is also received by an electric power inverter 235 with its own controller 250. The electric power inverter converts the DC voltage from the PEMFC 100 to AC voltage to operate an AC electric motor 260, with a speed controller motor, which drives the propulsion module 270. In some instances a DC motor may be preferable. The specification herein of an AC motor is not a limitation.

The speed of the PWC can be controlled by varying the electrical output of the fuel cell stack 100. The output of the fuel cell stack 100 can be varied by altering the hydrogen flow, via the hydrogen supply valve and/or altering the action of the compressor 130 and thereby varying the available oxygen. The speed of the PWC can also be controlled by varying the output of the inverter 235 and /or varying the speed of the electric motor 260. The speed of the electric motor 260 is adjusted by the motor speed control 265.

The size, current requirements, and output (Kilowatts) of the electric motor 260 are dependent on the intended to usage of the EFC PWC. An EFC PWC for a single rider may require a less powerful motor than a EFC PWC for two or more riders.

Components of the water jet propulsion module 270, shown in FIG. 1B, are a water tunnel 20, an impeller 22 (connected to a motor shaft 24 which extends from inside the hull 26, through a sealed guide 27, into the water tunnel 20), a tunnel opening 28 through the bottom of the hull 29, and a discharge nozzle 32.

The AC electric motor 260, with motor speed controller 265, provides the primary propulsion for the PWC. The electric power inverter 235 provides the AC current.

When the impeller 22 inside the water tunnel 20 rotates water is directed through the water tunnel 20 and forms a stream of water. The stream of water reaches the discharge nozzle 32 and exits the PWC. In this embodiment a steering nozzle 18 is connected to the discharge nozzle whereby the stream of water is movably directed. The discharge nozzle 32, in this embodiment, is placed near the centerline of the PWC 33 and at the backside of the hull 36. The stream of water passes through the steering nozzle and a water jet stream 500 exits. By controlling the direction of the water jet stream 500, relative to the PWC, the steering nozzle 18 is used in propulsion and navigation of the PWC.

The steering nozzle 18 is physically controlled by the movement of the handle bars on a support 16. An actuator 37 is connected to the handle bars on a support 16 and the steering nozzle 18. Known in the art are many types of actuators including but not limited to wire-actuators, mechanical, electrical and hydraulic. Accordingly, a detailed description of an actuator is not provided. The actuator 37, in this embodiment with a linking rod 38, connects the handle bars 16 to the steering nozzle 18. Any actuator which react to the movement of the handle bars 16 and will provide a corresponding movement of the steering nozzles 18 can be used without departing from the scope of this invention.

The fuel cell heat exchanger 135 is in thermal contact with a heat exchange region 40 of the bottom of the hull 29. If a reformer 175 is being used to provide hydrogen, a reformer heat exchanger 185 can also be placed in contact with the heat exchange region 40. The heat exchange region 40 is constructed with good thermal conducting properties whereby the heat from the operation of the PEMFC 100 is dissipated into the marine environment. The heat exchange region 40, at its interface 41 with the hull bottom 29, should be constructed to avoid heat damage to itself, the hull, or the interface 41. The heat exchange region may be constructed with channels, fins or have other surface features, which are known in the art, to increase the surface area for heat exchange. In the present embodiment a metallic material, such as stainless steel can be used to construct the heat exchange region 40. However, it is within the scope of this disclosure that other metallic and non-metallic materials, such as metal alloys, resins, composites, insert molded metal and plastic, and ceramics may be used to form at least a part of the heat exchange region.

Major components forming the balance of plant “BOP” for the fuel cell stack include,but are not limited to, the humidity control device 120, air compressor 130, and condenser 280 which receives a an exhaust stream from the cathode and condenses the water therein. The condensed water can be stored in a reservoir 290 for use by the humidity control device 120 thereby supplying a gaseous hydrogen flow to the PEMFC 100. The fuel cell power system is hereby defined as the combination of the fuel cell stack 100, power inverter 235, and the BOP components listed above.

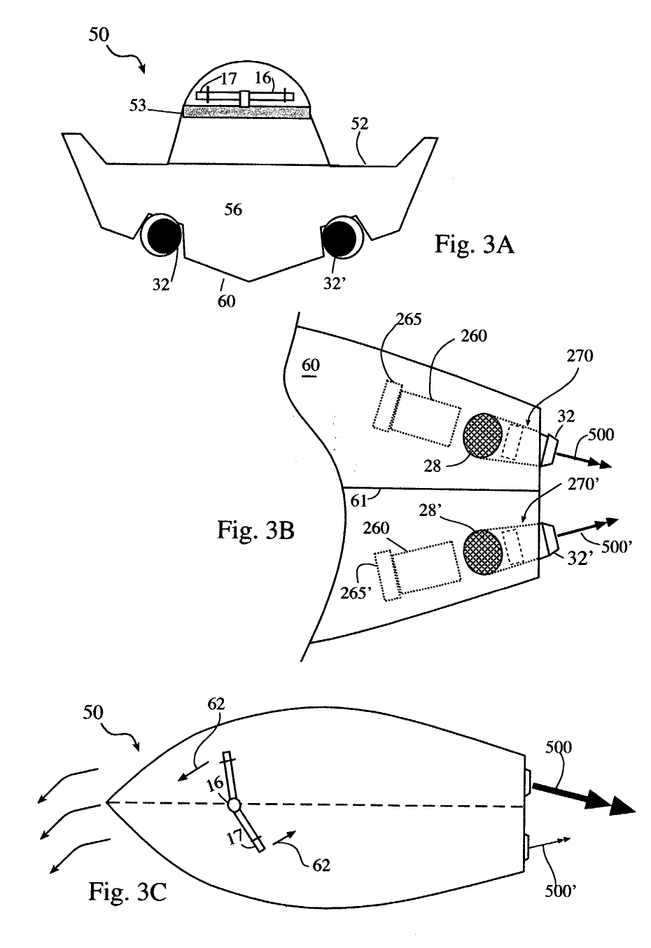

In FIG. 3A and 3B the EFC PWC 50 also has a hull 52 with a raised seat 53. Dual fixed discharge nozzles 32 & 32′, extend through the back of the hull 56. The dual fixed discharge nozzles 32 & 32′ are shown at a fixed angled with the water jet stream 500 & 500′ directed towards the centerline 61 of the hull 60. The first and second electric motors 260 & 260′ are each connected to a water jet propulsion module 270 propulsion module 270 and generally operates as described in reference to the embodiment described in FIGS. 1A-1E.

In this embodiment the water jet streams 500 & 500′ exits each water tunnel the discharge nozzles 32 & 32′. Weight shifting and varying the volume of discharged water in each of the water jet streams 500 & 500′ provide the propulsion and navigation. The volume of discharged water in a water jet stream is a time measurement. By varying the volume of water discharged over a period of time the PWC can be navigated, as shown in FIG. 3C.

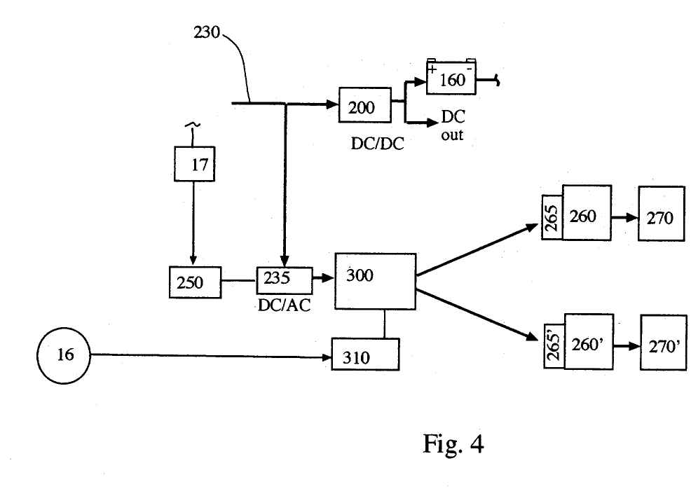

A load splitter 300, shown in FIG. 4 receives the an electrical output from the inverter 235. The load splitter can divide up the power directed to each motor 260 & 260′. The load splitter 300 is controlled by a load splitter controller 310. The PEMFC 100 supplies the current to the inverter 235. In this embodiment the movement of the handle bars 16 communicates with the load splitter controller 310 to vary the power to each motor 260 & 260′.

To turn the PWC left (shown in FIG. 3C) a user moves the handle bars 16 along the direction of arrow 62. The handle bar 16 movement communicates with the load splitter controller which directs the load splitter 300 to increases the electrical output to the right motor 260 as compared to the electrical output to the left motor 260′. The change in output to the electrical motors 260 & 260′ causes a change in the volume of discharged water in the water jet streams 500 & 500′. A rider can increase or decrease the forward speed of the PWC by adjustment of the total electrical output provided to the load splitter 300, via the hand grip 17.

Electric motor(s) 260 can also power a propeller (not shown) extending from the hull 14. The use of the aforementioned propulsion module (an impeller in a water tunnel with a discharge nozzle) to produce a water jet stream for propulsion is not a limitation of this invention. A propeller connected to a motor shaft can be used to provide propulsion and navigation to a fuel cell powered electric water craft. An impeller is preferred for those PWCs which have a rider above the hull, such a PWC can have riders approaching the PWC from the water and or falling off the PWC the impeller eliminates the risk of injury from a propeller.

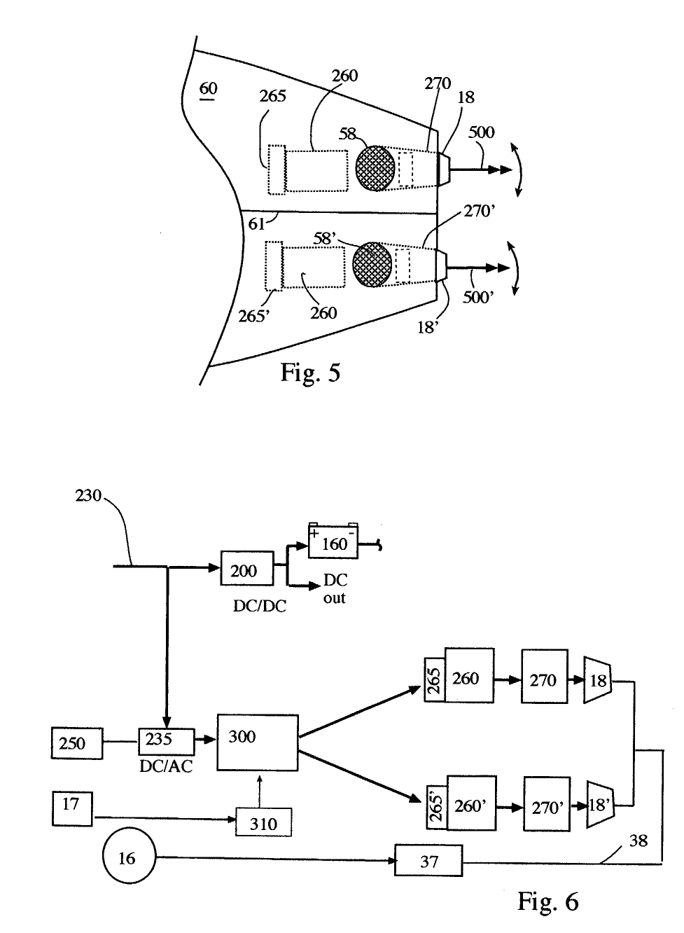

A dual motor PWC with dual with dual steerable nozzles 18 & 18′ is shown in FIGS. 5 & 6. In this embodiment the load splitter 300 provides equal electrical output to each motor 260 & 260′. Navigation is by the same general mechanism described in reference to the embodiment shown in FIG. 1A-1E. The steering nozzles 18 & 18′ are located on either side of the centerline 61 and move together. The steering nozzles are physically connected to each propulsion module 270 . The steering nozzles 18 & 18′ are controlled by the movement of the handle bars 16 which is connected to an actuator 37.

The load splitter 300, in this embodiment splits the load substantially evenly (generally to produce the same RPM per motor) between each motor 260 & 260′.

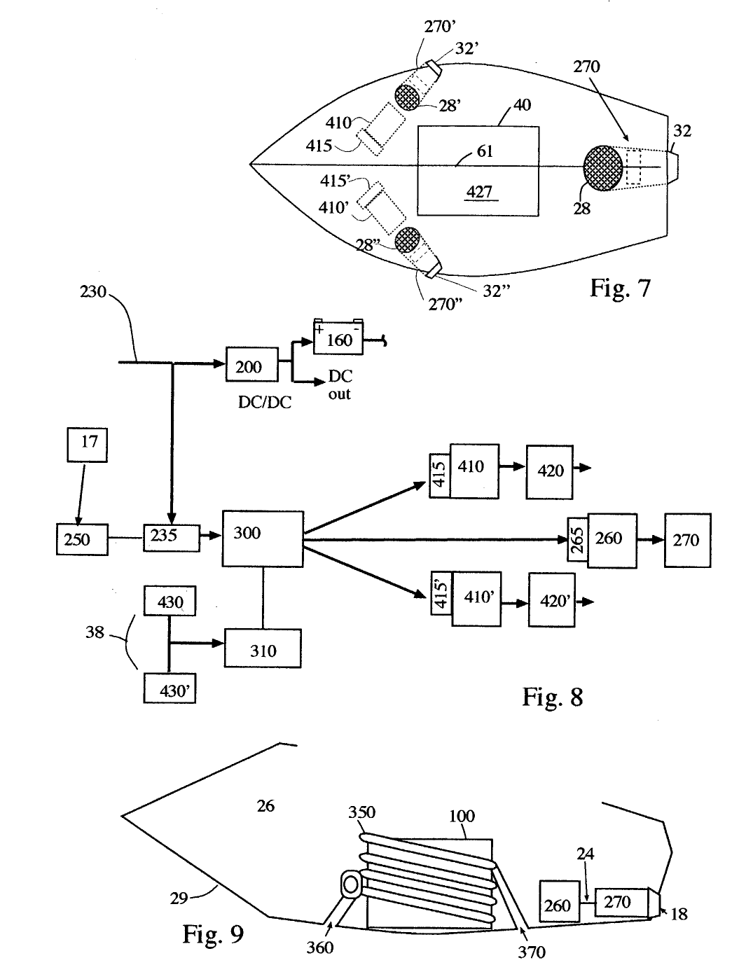

A triple electric motor PWC 70 is shown in FIGS. 7 & 8. In this embodiment the load splitter 300 provides electrical output to the rear motor 260 (and rearward propulsion module 270) and to the two forward steering motors 410 & 410′. The forward steering motors 410 & 410′, each with a motor controller 415 & 415′, are angled away from the center line 61 and each is connected to a forward propulsion module 270′ & 270″. In this embodiment the forward steering motors and/or the propulsion modules 270′ & 270″ are primarily for navigation and need not be of a size or output for primary propulsion.

As previously described, a load splitter 300 operates to direct a portion of the electricity from the PEMFC 100 to the different motors. Specifically, to the rear motor 260 and the forward steering motors 410 & 410′, as needed. To steer the PWC left a rider (not shown) engages an actuator 37 which communicates with the load splitter controller 310 to power the right forward steering motor 410′.

In this embodiment the actuator is an actuator system which communicates with the load splitter controller 310 comprises dual foot controls 430 & 430′. In this embodiment the foot controls 430 & 430′ actuates the load splitter controller 310. The foot controls may be mechanical, hydraulic, or “by-wire” (electrical). To turn the PWC left a rider (not shown) places uneven pressure on the dual foot controls, with more pressure on the left foot control 430, the change in pressure on the left foot control 430 actuates the load splitter controller 310 and the load splitter 300 increase the electrical output to the right forward steering motor 410′. A rider can increase or decrease the forward of the PWC by adjustment of the total electrical output provided to the load splitter 300, via the hand grip 17. The foot controls 430 & 430′ could also be used to control a mechanical actuator to control steering nozzles.

Shown in FIG. 9 is another EFC PWC. In this embodiment the fuel cell stack 100 is cooled with an open radiator 350. The open radiator 250 has an intake opening 360 and an exhaust opening 370 through the bottom of the hull 29. A pump 380 can be used to bring water from the marine environment onto the open radiator 250 for cooling the fuel cell stack 100 and then returning the water through the exhaust opening 370.

Since certain changes may be made in the above apparatus without departing from the scope of the invention herein involved, it is intended that all matter contained in the above description, as shown in the accompanying drawing, shall be interpreted in an illustrative, and not a limiting sense.

I claim:

1. A personal water craft comprising:
a hull with a hollow portion;
a fuel cell power system within the hull;
at least one electric motor, within the hull, to receive power from the fuel cell power system;
a hydrogen supply means for the fuel cell power system;
an oxygen supply means for the fuel cell power system;
a steering means for the personal water craft;
a speed control means for the personal water craft;
a propulsion module connected to each electric motor; and,
at least one seat.

2. The personal water craft of claim 1 wherein the steering means comprises:
a steering nozzle, connected to each propulsion module;
a movable handle bar on a support; and,
an actuator attached to the handle bar at one end and to each steering nozzle, whereby the movement of the handle bar moves each steering nozzle.

3. The personal water craft of claim 1 wherein the steering means comprises:
steering nozzle, connected to each propulsion module;
at least two foot controls; and,
an actuator attached to the foot controls at one end and to each steering nozzle, whereby the movement of the foot controls moves each steering nozzle.

4. The personal water craft of claim 1 wherein the speed control means comprises varying the electrical output of the fuel cell power system.

5. The personal water craft of claim 1 wherein the hydrogen supply means comprises hydrogen stored under pressure in a hydrogen storage tank connected to the fuel cell with a hydrogen feed line.

6. The personal water craft of claim 4 wherein the hydrogen supply means further comprises at least one valve.

7. The personal water craft of claim 1 wherein the oxygen supply means comprises an air compressor connected to the fuel cell with a air feed line.

8. A personal water craft comprising:
a hull with a hollow portion;
a fuel cell power system within the hull;
at least one electric motor, within the hull, to receive power from the fuel cell power system;
a hydrogen supply means for the fuel cell power system;
an oxygen supply means for the fuel cell power system;
a steering means for the personal water craft;
a speed control means for the personal water craft;
a heat exchanger means between at least a portion of the fuel cell power system and the hull, whereby the hull is in thermal contact with surrounding water;
a propulsion module connected to each electric motor; and,
at least one seat.

9. The personal water craft of claim 8 wherein the heat exchanger means comprises:
a finned metallic area in thermal contact with the fuel cell power system; and,
a heat exchange region of the hull bottom in thermal contact with the fuel cell power system and the marine environment.

10. The personal water craft of claim 8 wherein the heat exchanger means comprises:
an open radiator in thermal contact with the fuel cell power system;
at least one intake to the open radiator whereby water form the marine environment can enter the radiator; and,
at least one exhaust to the open radiator whereby water can leave the radiator and return to the marine environment.

11. A personal water craft comprising:
a hull with a hollow portion;
a fuel cell power system within the hull;
a load splitter;
at least two electric motors, within the hull, to receive power from the fuel cell power system via the load splitter;
a hydrogen supply means for the fuel cell power system;
an oxygen supply means for the fuel cell power system;
a steering means for the personal water craft;
a speed control means for the personal water craft;
two rearward facing propulsion modules each connected to an electric motor; and,
at least one seat.

12. The personal water craft of claim 11 wherein the steering means comprises varying the speed of at least one of the two electric motors.

13. The personal water craft of claim 11 wherein the steering means comprises:
a steering nozzle, connected to each propulsion module;
a movable handle bar on a support; and,
an actuator attached to the handle bar at one end and to each steering nozzle, whereby the movement of the handle bar moves each steering nozzle.

14. The personal water craft of claim 12 wherein the steering means comprises:
at least two foot controls; and,
an actuator attached to the foot controls at one end and to the load splitter whereby the movement of the foot controls the speed of the electric motors.

15. A personal water craft comprising:
a hull with a hollow portion;
a fuel cell power system within the hull;
a load splitter;
at least one rearward electric motor, within the hull, to receive power from the fuel cell power system via the load splitter;
at least two forward electric motors, within the hull, to receive power from the fuel cell power system via the load splitter;
a hydrogen supply means for the fuel cell power system;
an oxygen supply means for the fuel cell power system;
a steering means for the personal water craft;
a speed control means for the personal water craft;
a propulsion module connected to each electric motor; and, at least one seat.

16. The personal water craft of claim 14 wherein the steering means comprises:
a rearward facing propulsion module;
equal number of forward motors on opposite sides of the hull; and, one or more pairs of forward propulsion module each member of the pair extending through an opposite side of the hull and at the same, but opposite angle; whereby each forward propulsion module producing a water jet stream of the same volume would result in the personal water craft, being steered generally straight ahead.

17. A method of electric propulsion for a personal water craft the method comprising:
mounting a fuel cell power system within the hull of a personal water craft;
providing a hydrogen supply to the fuel cell power system;
providing an oxygen supply to the fuel cell power system;
generating electricity from the fuel cell power system; and
providing the fuel cell generated electricity to an electric motor which operates the propulsion means for the personal water craft.

18. The method of propulsion of claim 17, the method further comprising thermally connecting the fuel cell power system to through the hull to the marine environment to manage the heat of the fuel cell power system.
